(19) United States
(12) Patent Application Publication
(10) Pub. No.: US 2025/0304447 A1
(43) Pub. Date: Oct. 2, 2025

(54) METHOD FOR REGENERATING CARBON FIBER BUNDLE AND APPARATUS FOR REGENERATING CARBON FIBER BUNDLE

(71) Applicant: HONDA MOTOR CO., LTD., Tokyo (JP)

(72) Inventor: Masato NOGUCHI, Saitama (JP)

(21) Appl. No.: 19/008,243

(22) Filed: Jan. 2, 2025

(30) Foreign Application Priority Data
Mar. 29, 2024 (JP) 2024-056174

(51) Int. Cl. C01B 32/05

(52) U.S. Cl. CPC C01B 32/05; C01P 2004/90

(57) ABSTRACT

Provided is a method for regenerating a carbon fiber bundle from a structure having a hollow substrate, and a carbon fiber reinforced resin layer including a carbon fiber bundle wound on the hollow substrate, and a matrix resin, the structure including an opening provided in at least one end portion in a longitudinal direction, the method including a suspending process of suspending the structure by fixing the end portion that is disposed on an upper side in a vertical direction and has the opening provided therein, without closing the opening, a first heating process of heating the suspended structure to decompose the matrix resin, an unwinding process of unwinding an intermediate carbon fiber bundle to which decomposition residue of the matrix resin is adhering from the carbon fiber reinforced resin layer in which the matrix resin is decomposed.

This application is based on and claims the benefit of priority from Japanese Patent Application No. 2024-056174, filed on 29 Mar. 2024, the content of which is incorporated herein by reference.

### BACKGROUND OF THE INVENTION

### Field of the Invention

The present invention relates to a method for regenerating a carbon fiber bundle, and an apparatus for regenerating a carbon fiber bundle.

### Related Art

In recent years, by preventing generation of waste, and reducing, recycling and reusing waste, efforts to significantly reduce generation of waste have become more and more active. In order to realize this, research and development on methods for recovering carbon fibers from carbon fiber reinforced resin is being conducted.

PCT International Publication No. WO2020/179915 describes a recycling apparatus for a tank that includes a liner that is an inner shell, and a reinforcement layer that is molded so that carbon fiber reinforced plastic containing carbon fibers and a matrix component covers the liner, and has opening portions provided on both end portion sides of the liner. Here, the recycling apparatus for the tank includes a carbonization and dry distillation furnace having a carbonization and dry distillation chamber that houses the tank, a heating chamber surrounding the carbonization and dry distillation chamber, and a combustion chamber that raises the temperature of the heating chamber including the carbonization and dry distillation chamber, and a frame for storing the tank in which a suspension tool is attached to the opening portion located on an upper side. Furthermore, the frame includes a plurality of column members that are longer than the tank, and a girder member that is spanned across the column members and locks the suspension tool.
Patent Document 1: PCT International Publication No. WO2020/179915

### SUMMARY OF THE INVENTION

At this time, when the liner is formed of resin, it is considered to use the recycling apparatus for a tank in PCT International Publication No. WO2020/179915, but the suspension tool is attached to the opening portion provided on the upper end portion side of the tank, and the opening portion is closed. Therefore, inflow of water vapor from the opening portion provided on the upper end portion side of the tank is restrained, and the resin forming the liner is difficult to dry by distillation, in addition to which, gas that is generated as a result of the resin being dried by distillation is also restrained from flowing out from the opening portion provided on the upper end portion side of the tank, as a result of which, the dry distillation time of the tank increases.

The present invention has an object to provide a method for regenerating a carbon fiber bundle and an apparatus for regenerating a carbon fiber bundle that can shorten a heating time of a structure.

[1]A method for regenerating a carbon fiber bundle from at least one structure having a hollow substrate, and a carbon fiber reinforced resin layer including a carbon fiber bundle wound on the hollow substrate and a matrix resin, the at least one structure including an opening provided in at least one end portion in a longitudinal direction, the method including a suspending process of suspending the at least one structure by fixing the end portion that is disposed on an upper side in a vertical direction, and has the opening provided therein, without closing the opening, a first heating process of heating the at least one suspended structure to decompose the matrix resin, an unwinding process of unwinding an intermediate carbon fiber bundle to which decomposition residue of the matrix resin is adhering from the carbon fiber reinforced resin layer in which the matrix resin is decomposed, a second heating process of heating the unwound intermediate carbon fiber bundle to decompose the decomposition residue of the matrix resin to obtain a regenerated carbon fiber bundle, and a winding process of winding the regenerated carbon fiber bundle.

[2] In the method for regenerating a carbon fiber bundle as described in [1], the hollow substrate includes a resin.

[3] In the method for regenerating a carbon fiber bundle as described in [1] or [2], the at least one structure that is suspended is heated under an environment including oxygen.

[4] In the method for regenerating a carbon fiber bundle as described in any one of [1] to [3], the at least one structure includes a plurality of structures, the plurality of structures are suspended, and the plurality of structures that are suspended are heated.

[5] An apparatus for regenerating a carbon fiber bundle from at least one structure having a hollow substrate, and a carbon fiber reinforced resin layer including a carbon fiber bundle wound on the hollow substrate and a matrix resin, the at least one structure including an opening provided in at least one end portion in a longitudinal direction, the apparatus including a suspender that suspends the at least one structure by fixing the end portion that is disposed on an upper side in a vertical direction and has the opening provided therein, without closing the opening, a first heater that heats the at least one structure fixed by the suspender to decompose the matrix resin, an unwinder that unwinds an intermediate carbon fiber bundle to which decomposition residue of the matrix resin is adhering from the carbon fiber reinforced resin layer in which the matrix resin is decomposed, a second heater that heats the unwound intermediate carbon fiber bundle to decompose the decomposition residue of the matrix resin to obtain a regenerated carbon fiber bundle, and a winder that winds the regenerated carbon fiber bundle.

[6] In the apparatus for regenerating a carbon fiber bundle as described in [5], the suspender has at least one jig that clamps an outer peripheral surface of the end portion that is disposed on the upper side in the vertical direction and has the opening provided therein.

[7] In the apparatus for regenerating a carbon fiber bundle as described in [6], the at least one structure includes a plurality of structures, the suspender suspends the plurality of structures, and the at least one jig clamps the outer peripheral surface of each of end portions in which the opening is provided, of the plurality of structures.

[8] In the apparatus for regenerating a carbon fiber bundle as described in [5], the suspender has at least one jig that is screwed into an opening disposed on the upper side in the vertical direction, and in the at least one jig, a through-hole is provided not to close the opening.

[9] In the apparatus for regenerating a carbon fiber bundle as described in [8], the at least one structure includes a plurality of structures, the suspender suspends the plurality of structures, and the at least one jig includes a plurality of jigs.

[10] In the apparatus for regenerating a carbon fiber bundle as described in any one of [5] to [9], the suspender further has a plate-shaped member that is disposed to face and contact an end portion disposed on a lower side in the vertical direction of the at least one structure, and a through-hole is provided in the plate-shaped member.

According to the present invention, it is possible to provide the method for regenerating a carbon fiber bundle and the apparatus for regenerating a carbon fiber bundle that can shorten the heating time of the structure.

### BRIEF DESCRIPTION OF THE DRAWINGS

FIG. 1 is a sectional view showing one example of a high-pressure hydrogen tank in which mouthpieces are detached;

FIG. 2 is a perspective view showing one example of a suspender that suspends the high-pressure hydrogen tank in FIG. 1;

FIG. 3 is a perspective view showing a modification of the suspender in FIG. 2;

FIG. 4 is a partially enlarged sectional view of the suspender in FIG. 3;

FIG. 5 is a view showing one example of a first heater that is used in a first heating process;

FIG. 6A and FIG. 6B are views showing one example of an unwinder that is used in an unwinding process; and

FIG. 7 is a schematic view showing examples of a second heater, a sizing unit, and a winder that are used in a second heating process, a sizing process, and a winding process.

### DETAILED DESCRIPTION OF THE INVENTION

Hereinafter, an embodiment of the present invention will be described with reference to the drawings.

A method for regenerating a carbon fiber bundle according to one embodiment of the present invention is a method for regenerating a carbon fiber bundle from a structure having a hollow substrate, and a carbon fiber reinforced resin layer including a carbon fiber bundle wound on the hollow substrate, and a matrix resin, in which an opening portion is provided in at least one end portion in a longitudinal direction. Although the structure is not particularly limited, for example, known high-pressure hydrogen tanks (types 2 to 4) in which mouthpieces are detached are cited.

Although the carbon fibers composing the carbon fiber bundle are not particularly limited, for example, polyacrylonitrile (PAN) carbon fibers, and pitch carbon fibers are cited. Here, the carbon fibers composing the carbon fiber bundle are long fibers. Fiber lengths of the carbon fibers are not particularly limited, but are 1 m or more, for example. Although the matrix resin is not particularly limited, for example, cured products of thermosetting resins such as epoxy resins, and thermoplastic resins are cited.

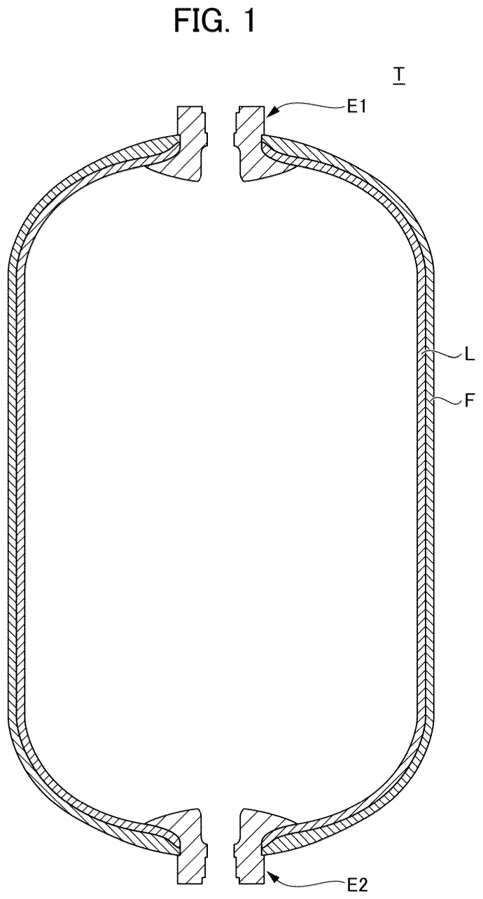

FIG. 1 shows an example of the high-pressure hydrogen tank in which mouthpieces are detached.

A high-pressure hydrogen tank T in which mouthpieces are detached (hereinafter, referred to as a high-pressure hydrogen tank T) has a liner L, as a hollow substrate, a carbon fiber reinforced resin layer F including a carbon fiber bundle that is wound on the liner L, and a matrix resin, and openings are provided in end portions E1 and E2 in a longitudinal direction. Although a material forming the liner L is not particularly limited, for example, metal such as aluminum, and chrome molybdenum steel, and resins such as polyamide, and polyethylene are cited.

Although the method for manufacturing the high-pressure hydrogen tank T is not particularly limited, for example, a filament winding method is cited.

The method for regenerating a carbon fiber bundle according to one embodiment of the present invention includes a suspending process of fixing the end portion E1 that is disposed on an upper side in a vertical direction and has an opening provided therein, without closing the opening, to suspend the high-pressure hydrogen tank T, and a first heating process of heating the suspended high-pressure hydrogen tank T under a first environment including oxygen to decompose the matrix resin. Furthermore, the method for regenerating a carbon fiber bundle according to one embodiment of the present invention further includes an unwinding process of unwinding an intermediate carbon fiber bundle I to which decomposition residue of the matrix resin is adhering from the carbon fiber reinforced resin layer F in which the matrix resin is decomposed. Furthermore, the method for regenerating a carbon fiber bundle according to one embodiment of the present invention further includes a second heating process of heating the unwound intermediate carbon fiber bundle I under a second environment including oxygen to decompose the decomposition residue of the matrix resin to obtain a regenerated carbon fiber bundle R, and a winding process of winding the regenerated carbon fiber bundle R.

In the present description and the claims, “suspending the structure” includes a state in which an end portion disposed on a lower side in the vertical direction of the structure is in contact with another member, in addition to a state in which the end portion disposed on the lower side in the vertical direction of the structure is not in contact with another member.

In the suspending process, the end portion E1 is fixed without closing the opening provided in the end portion E1. At this time, the high-pressure hydrogen tank T is held so that the longitudinal direction of the high-pressure hydrogen tank T is substantially parallel to the vertical direction. Therefore, even when the liner L is formed of a resin, inflow of oxygen from the end portion E1 of the high-pressure hydrogen tank T is not restrained, and the resin forming the liner L is easily decomposed thermally, in addition to which, outflow of decompression gas of the resin forming the liner L from the end portion E1 of the high-pressure hydrogen tank T is not restrained, either, in the first heating process. As a result, a heating time of the high-pressure hydrogen tank T is shortened. Furthermore, since the end portion E2 of the high-pressure hydrogen tank T is not fixed, distortion that is applied to the high-pressure hydrogen tank T is restrained even if a jig that fixes the end portion E1 is linearly expanded by heating.

Furthermore, in the suspending process, the opening that is provided in the end portion E2 that is disposed on the lower side in the vertical direction of the high-pressure hydrogen tank T is not closed, either. Therefore, even when the liner L is formed of a resin, inflow of oxygen from the end portion E2 of the high-pressure hydrogen tank T is not restrained, in addition to which, outflow of a pyrolysis liquid of the resin forming the liner L from the end portion E2 of the high-pressure hydrogen tank T is not restrained, either, in the first heating process. As a result, the resin forming the liner L is easily decomposed thermally, and the high-pressure hydrogen tank T becomes difficult to deform. Furthermore, since the matrix resin is thermally decomposed equally in a thickness direction of the carbon fiber reinforced resin layer F, a content of the decomposition residue of the matrix resin in the intermediate carbon fiber bundler I is uniformized.

Here, when the content of the decomposition residue of the matrix resin in the intermediate carbon fiber bundle I is adjusted to a predetermined range, damage to the intermediate carbon fiber bundle I is restrained when the intermediate carbon fiber bundle I to which the decomposition residue of the matrix resin is adhering is unwound from the carbon fiber reinforced resin layer in which the matrix resin is decomposed. A content of the decomposition residue of the matrix resin in the intermediate carbon fiber bundle 1 is, for example, 5 weight % or more and 10 weight % or less.

Note that in the suspending process, a plurality of high-pressure hydrogen tanks T may be suspended, and in the first heating process, the plurality of high-pressure hydrogen tanks T that are suspended may be heated.

As the first heater used in the first heating process, for example, a hot air circulation furnace, and a gas furnace are cited.

Note that in the first heating process, the high-pressure hydrogen tank T may be heated by superheated steam. Furthermore, in the second heating process, the intermediate carbon fiber bundle I may be heated by superheated steam.

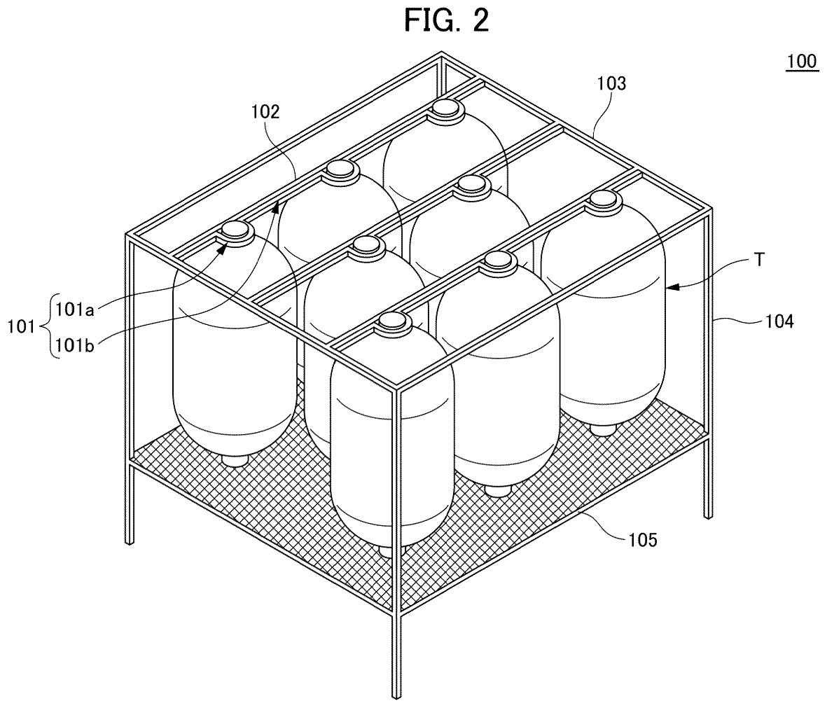

FIG. 2 shows one example of the suspender that suspends the high-pressure hydrogen tank T.

A suspender 100 has a jig 101 that clamps outer peripheral surfaces of the end portions E1 disposed on the upper side in the vertical direction of the plurality of high-pressure hydrogen tanks T, a beam-shaped member 102, a girder-shaped member 103, and column-shaped members 104. Here, the jig 101 includes a plurality of U-shaped clampers 101a, and rod-shaped portions 101b disposed on both sides of each of the clampers 101a. At this time, the rod-shaped portion 101b is fixed to the beam-shaped member 102 by a bolt and nut, for example. Furthermore, the beam-shaped member 102 is spanned between girder-shaped members 103 facing each other, and the girder-shaped member 103 is spanned between the adjacent column-shaped members 104.

The suspender 100 further has a plate-shaped member 105 that is disposed to face and contact the end portion E2 disposed on the lower side in the vertical direction of the high-pressure hydrogen tank T, and in the plate-shaped member 105, through-holes are provided. Here, the plate-shaped member 105 is supported by the column-shaped members 104. Furthermore, below the plate-shaped member 105, a tray in which the pyrolysis liquid of the resin forming the liner L flows is disposed.

The plate-shaped member 105 is not particularly limited, if only it has the through-holes that do not restrain outflow of the pyrolysis liquid of the resin forming the liner L from the end portion E2 of the high-pressure hydrogen tank T, and, for example, wire mesh, and punching metal are cited.

Note that the suspender 100 may have the jig 101 that clamps the outer peripheral surface of the end portion E1 disposed on the upper side in the vertical direction of the single high-pressure hydrogen tank T. Furthermore, in the beam-shaped member 102, a region facing the clamper 101a may be in a U-shape. Furthermore, the plate-shaped member 105 may be disposed at a predetermined space from the end portion E2 disposed on the lower side in the vertical direction of the high-pressure hydrogen tank T.

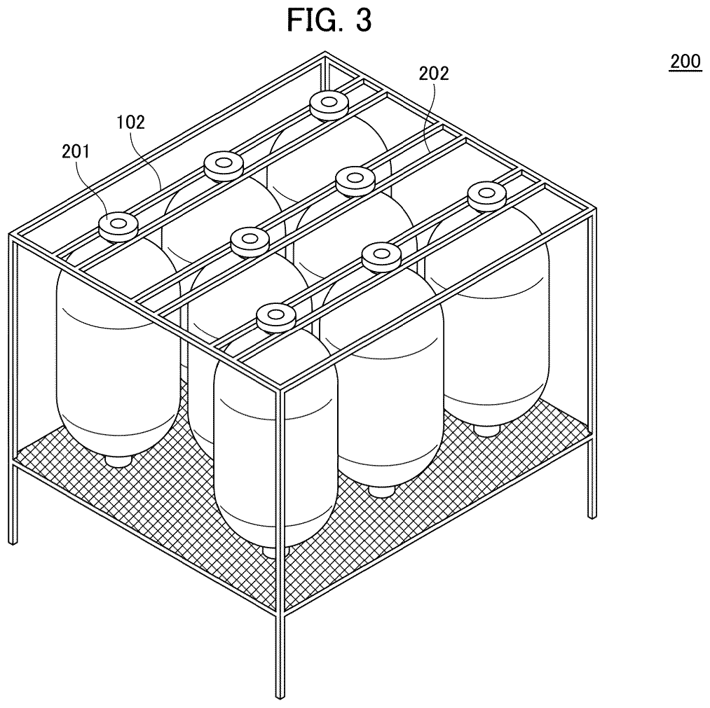

FIG. 3 shows a modification of the suspender 100.

A suspender 200 has a same configuration as that of the suspender 100 except that the suspender 200 has a jig 201 that is screwed into an opening provided in an end portion E1 disposed on an upper side in the vertical direction of each of high-pressure hydrogen tanks T, instead of the jig 101, and that the jig 201 is supported by beam-shaped members 102 and 202.

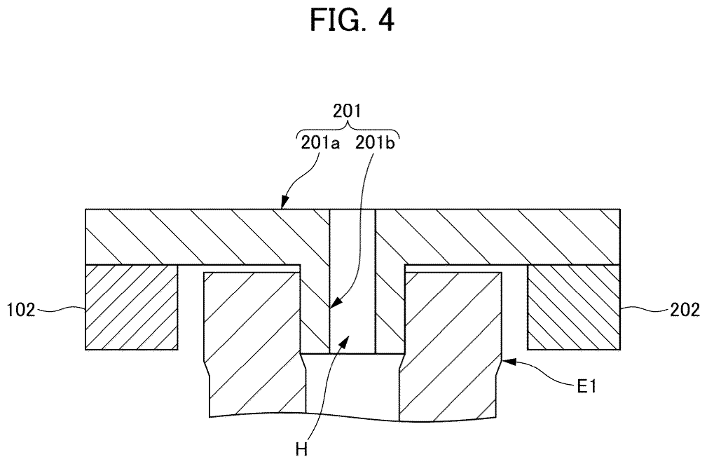

As shown in FIG. 4, the jig 201 includes a base material portion 201a in a hollow disk shape, and a screw-in portion 201b in a cylindrical shape that extends from an inner peripheral portion of the base material portion 201a, and a through-hole H is provided in a center portion. Here, an outside diameter of the screw-in portion 201b is substantially a same as an inside diameter of the opening provided in the end portion E1 of the high-pressure hydrogen tank T. At this time, the base material portion 201a is fixed to the beam-shaped members 102 and 202 by bolts and nuts, for example.

Note that the suspender 200 may have the single jig 201. Furthermore, the beam-shaped member 202 may be a movable type of beam-shaped member that rotates with the beam-shaped member 102 as a support point.

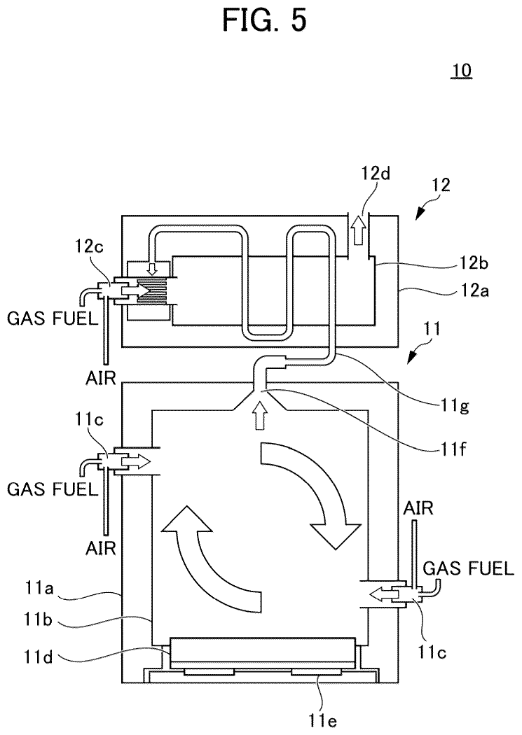

FIG. 5 shows a heat treatment furnace as one example of the first heater used in the first heating process.

A heat treatment furnace 10 has a heat treatment chamber 11 and a combustion chamber 12.

The heat treatment chamber 11 is a hermetically sealed space surrounded by an outer wall 11a and an inner wall 11b. Furthermore, in the heat treatment chamber 11, burners 11c are provided at an upper part of the outer wall 11a on a left side and at a lower part of the outer wall 11a on a right side in the drawing so that combustion gas flows into the inner wall 11b. Therefore, when a gas fuel and air are mixed and combusted with the burners 11c, the combustion gas circulates by convection in the inner wall 11b, and a temperature in the inner wall 11b is stabilized.

In the heat treatment chamber 11, a sealing door for housing the high-pressure hydrogen tank T that is suspended by the suspender 100 is installed in parts of the outer wall 11a and the inner wall 11b. Here, the high-pressure hydrogen tank T is placed on a thermal insulator 11d that is installed to penetrate a bottom surface of the inner wall 11b. Furthermore, a load cell lie as a mass detector is installed between a bottom surface of the outer wall 11a and the thermal insulator 11d, and detects a mass of the high-pressure hydrogen tank T in real time, based on a distortion amount. Since heating conditions in the heat treatment chamber 11 are thereby optimized, variations in the decomposition amount of the matrix resin due to individual differences in the material forming the high-pressure hydrogen tank T, the shape and the like are restrained, and management accuracy is improved. Furthermore, since the heating time in the heat treatment chamber 11 does not have to be longer than necessary, this contributes to shortening of the heating time and reduction in energy consumption amount.

Note that the mass detector may detect a decrease amount of the mass of the high-pressure hydrogen tank T in real time. Furthermore, as necessary, the mass detector may be omitted.

The decomposition gas of the matrix resin generated inside the inner wall 11b is discharged from an exhaust port 11f that is provided in an upper portion of the inner wall 11b in the drawing, and thereafter, is introduced into the combustion chamber 12 via a pipe 11g that is installed by penetrating the outer wall 11a.

The combustion chamber 12 is a hermetically sealed space with a periphery thereof surrounded by an outer wall 12a and an inner wall 12b. Furthermore, in the combustion chamber 12, a burner 12c is provided in a center portion of the outer wall 12a on a left side in the drawing so that the combustion gas flows into the inner wall 12b. The pipe 11g penetrates the outer wall 12a, then penetrates the inside and an outside of the inner wall 12b, in the outer wall 12a, and is finally connected to an upper left part of the inner wall 12b in the drawing. At this time, while the decomposition gas of the matrix resin passes through the pipe 11g inside the inner wall 12b, the decomposition gas of the matrix resin is heated by the combustion gas flowing inside the inner wall 12b, thereafter, is introduced from the upper left part of the inner wall 12b, and contacts the combustion gas. Thereby, the decomposition gas of the matrix resin is combusted, and then is exhausted to the outside from the exhaust port 12d.

Note that the heat treatment furnace 10 may further have a pipe that supplies exhaust heat of the combustion chamber 12 to a tube furnace 40 described later.

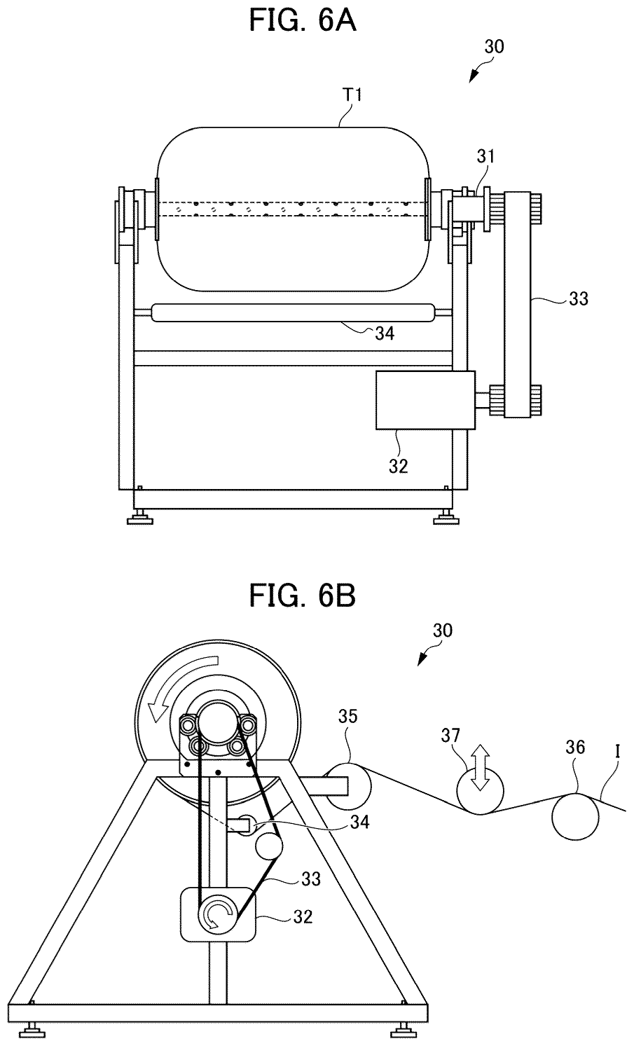

FIG. 6A and FIG. 6B show an example of an unwinder that is used in an unwinding process. Note that FIG. 6A and FIG. 6B are respectively a front view and a side view.

An unwinder 30 has a rotating jig 31 that rotatably supports a high-pressure hydrogen tank T1 in which the matrix resin is decomposed, and a motor 32 that rotates the high-pressure hydrogen tank T1. Rotational power of the motor 32 is transmitted to the rotating jig 31 via a belt 33. As a result, the intermediate carbon fiber bundle I is unwound via rollers 34, 35 and 36. In this case, the roller 34 is disposed so that the intermediate carbon fiber bundle I is unwound to outside from a tangent line in a position where the intermediate carbon fiber bundle I of the high-pressure hydrogen tank T1 is unwound. Furthermore, the rollers 34, 35, and 36 have long shafts so as to correspond to unwinding of the intermediate carbon fiber bundle I in a lengthwise direction of the high-pressure hydrogen tank T1. Furthermore, in order to absorb a difference in an unwinding amount per one rotation by hoop winding and helical winding of the intermediate carbon fiber bundle I, a dancer roller 37 that controls unwinding tension is installed.

Note that instead of the roller 34, a blade may be installed.

Note that after the sizing process for sizing the regenerated carbon fiber bundle R is carried out, the regenerated carbon fiber bundle R that is sized may be unwound.

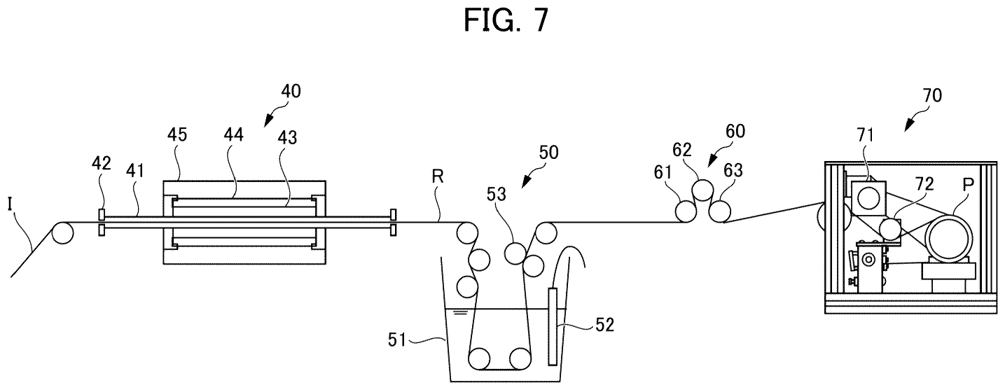

FIG. 7 shows examples of a second heater, a sizing unit, and a winder that are used in the second heating process, the sizing process, and the winding process.

In the tube furnace 40 as the second heater, thermally insulated lids 42 in which through-holes that allow the intermediate carbon fiber bundle I to which the decomposition residue of the matrix resin is adhering to pass through are provided are installed at both ends of a quartz tube 41. Furthermore, in the tube furnace 40, a heating wire 43, a thermal insulator 44, and a protection cover 45 are sequentially installed in a center portion of the quartz tube 41. Because of this, by the heating wire 43, the intermediate carbon fiber bundle I is heated, the decomposition residue of the matrix resin is decomposed, and thereby the regenerated carbon fiber bundle R is obtained. At this time, in addition to the temperature distribution in the tube furnace 40 being made uniform, heating of anything other than the intermediate carbon fiber bundle I is restrained.

A sizing unit 50 causes the regenerated carbon fiber bundle R to pass through a sizing liquid 51. At this time, a heater 52 heats the sizing liquid 51. Furthermore, a roller 53 prevents excessive application of the sizing liquid 51 to the regenerated carbon fiber bundle R.

Note that as necessary, a drying furnace may be installed to dry the regenerated carbon fiber bundle R.

A feeding mechanism 60 has feeder rollers 61, 62, and 63, and uses friction between the feeder rollers 61, 62 and 63 and the regenerated carbon fiber bundle R to control a linear speed of the regenerated carbon fiber bundle R to a linear speed that facilitates process management.

A winder 70 includes a winding motor 71 for winding the regenerated carbon fiber bundle R on a paper core P, and a slide roller 72 for traverse winding of the regenerated carbon fiber bundle R. In this case, by controlling torque of the winding motor 71, winding tension of the regenerated carbon fiber bundle R is controlled.

Although the embodiment of the present invention is described above, the present invention is not limited to the above-described embodiment, and the above-described embodiment may be appropriately changed within the scope of the gist of the present invention.

### EXPLANATION OF REFERENCE NUMERALS

100, 200 suspender
101, 201 jig
101a clamper
101b rod-shaped portion
102, 202 beam-shaped member
103, girder-shaped member
104 column-shaped member
201a base material portion
201b screw-in portion
E1, E2 end portion
F carbon fiber reinforced resin layer
H through-hole
I intermediate carbon fiber bundle
L liner
R regenerated carbon fiber bundle
T, T1 high-pressure hydrogen tank

What is claimed is:

1. A method for regenerating a carbon fiber bundle from at least one structure having a hollow substrate, and a carbon fiber reinforced resin layer including a carbon fiber bundle wound on the hollow substrate and a matrix resin, the at least one structure including an opening provided in at least one end portion in a longitudinal direction, the method comprising:
a suspending process of suspending the at least one structure by fixing the end portion that is disposed on an upper side in a vertical direction, and has the opening provided therein, without closing the opening;
a first heating process of heating the at least one suspended structure to decompose the matrix resin;
an unwinding process of unwinding an intermediate carbon fiber bundle to which decomposition residue of the matrix resin is adhering from the carbon fiber reinforced resin layer in which the matrix resin is decomposed;
a second heating process of heating the unwound intermediate carbon fiber bundle to decompose the decomposition residue of the matrix resin to obtain a regenerated carbon fiber bundle; and
a winding process of winding the regenerated carbon fiber bundle.

2. The method for regenerating a carbon fiber bundle according to claim 1, wherein the hollow substrate includes a resin.

3. The method for regenerating a carbon fiber bundle according to claim 1, wherein the at least one structure that is suspended is heated under an environment including oxygen.

4. The method for regenerating a carbon fiber bundle according to claim 1, wherein the at least one structure comprises a plurality of structures, the plurality of structures are suspended, and
the plurality of structures that are suspended are heated.

5. An apparatus for regenerating a carbon fiber bundle from at least one structure having a hollow substrate, and a carbon fiber reinforced resin layer including a carbon fiber bundle wound on the hollow substrate and a matrix resin, the at least one structure including an opening provided in at least one end portion in a longitudinal direction, the apparatus comprising:
a suspender that suspends the at least one structure by fixing the end portion that is disposed on an upper side in a vertical direction and has the opening provided therein, without closing the opening;
a first heater that heats the at least one structure fixed by the suspender to decompose the matrix resin;
an unwinder that unwinds an intermediate carbon fiber bundle to which decomposition residue of the matrix resin is adhering from the carbon fiber reinforced resin layer in which the matrix resin is decomposed;
a second heater that heats the unwound intermediate carbon fiber bundle to decompose the decomposition residue of the matrix resin to obtain a regenerated carbon fiber bundle; and
a winder that winds the regenerated carbon fiber bundle.

6. The apparatus for regenerating a carbon fiber bundle according to claim 5, wherein the suspender has at least one jig that clamps an outer peripheral surface of the end portion that is disposed on the upper side in the vertical direction and has the opening provided therein.

7. The apparatus for regenerating a carbon fiber bundle according to claim 6,
wherein the at least one structure comprises a plurality of structures, the suspender suspends the plurality of structures, and
the at least one jig clamps the outer peripheral surface of each of end portions in which the opening is provided, of the plurality of structures.

8. The apparatus for regenerating a carbon fiber bundle according to claim 5,
wherein the suspender has at least one jig that is screwed into an opening disposed on the upper side in the vertical direction, and
in the at least one jig, a through-hole is provided so as not to close the opening.

9. The apparatus for regenerating a carbon fiber bundle according to claim 8, wherein the at least one structure comprises a plurality of structures, the suspender suspends the plurality of structures, and the at least one jig comprises a plurality of jigs.

10. The apparatus for regenerating a carbon fiber bundle according to claim 5,
wherein the suspender further has a plate-shaped member that is disposed to face and contact an end portion disposed on a lower side in the vertical direction of the at least one structure, and
a through-hole is provided in the plate-shaped member.
